(19) United States
(12) Patent Application Publication
(10) Pub. No.: US 2016/0281858 A1
(43) Pub. Date: Sep. 29, 2016

(54) VALVE, NOTABLY FOR COMBUSTION ENGINE AIR CIRCUIT

(71) Applicant: VALEO SYSTEMES DE CONTROLE MOTEUR, Cergy Saint Christophe (FR)

(72) Inventor: Grégory HODEBOURG, Sartrouville (FR)

(73) Assignee: Valeo Systemes de Controle Moteur, Cergy Saint Christophe (FR)

(21) Appl. No.: 14/442,302

(22) PCT Filed: Nov. 8, 2013
(86) PCT No.: PCT/FR2013/052684

§ 371 Date: May 12, 2015

(30) Foreign Application Priority Data
Nov. 12, 2012 (FR) 1260715

(51) Int. Cl. F16K 1/226; F01N 13/08; F02M 35/10; F16K 11/052; F02M 26/65

(52) U.S. Cl. CPC F16K 1/2261; F16K 11/0525; F02M 26/65; F02M 35/10255; F01N 13/08

(57) ABSTRACT

Valve (1), notably for a combustion engine air circuit, comprising:—a body (2a, 2b) in which there are formed a main duct (5) and an auxiliary duct (6) opening into the main duct (5),—a shutter (3) pivot mounted in the body (2a, 2b) via a spindle (4), the shutter (3) comprising a first portion (10) able to shut off all or part of the main duct (5) when the shutter (3) is in a first position, and a second portion (11) able to shut off all or part of the auxiliary duct (6) when the shutter (3) is in a second position, and—at least one seal (19) borne by at least one of the portions, first (10) and second (11), of the shutter and arranged in such a way as to become interposed between at least a zone of said portion (10, 11) and at least one zone of the body when the shutter (3) is in the first or the second position.

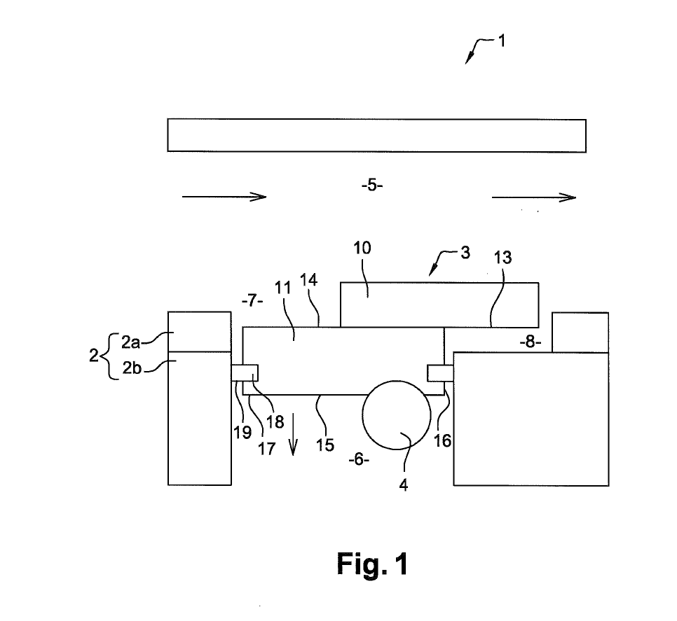

This invention relates to a valve, in particular a valve for the air circuit of a thermal engine.

The invention applies in particular when the thermal engine is used for the propulsion of a vehicle, for example a motor vehicle. It may be a petrol- or diesel-fuelled engine. The valve may be incorporated into the air circuit of the thermal engine.

Within the meaning of the invention, the “air circuit of a thermal engine” is the circuit between the thermal engine's intake and the exhaust. The valve can be arranged in the intake circuit, the exhaust circuit, or a recirculation loop through with the exhaust gases re-injected at the intake pass (EGR—Exhaust Gas Recirculation).

The valve described is a “three-way” valve. This valve is for example arranged at a branch connection defining three ways through which fluid can pass and allows the fluid communication between these three ways to be modified.

A known method of ensuring the tightness of one of the valve ways, is to arrange a seal within this way, for example between two castings delimiting this way, so that a shutter of the valve rests against this seal when this shutter is in a position opposing the fluid communication between this way and one and/or the other of the two other ways. In this case, the seal and the shutter are bearing in parallel planes, so that relatively large leaks can occur resulting in a relatively marked soiling of the seal and shutter.

The aim of the invention is to benefit from a “three-way” valve, in particular for a thermal engine's air circuit, which overcomes the above drawbacks.

The invention achieves this, according to one of its aspects, with the aid of a valve, in particular for a thermal engine's air circuit, comprising:
a body in which are arranged a main pipe and an auxiliary pipe feeding into the main pipe,
a shutter pivotably mounted in the body on a rod, the shutter comprising a first portion, capable of closing off all or part of the main pipe when the shutter is in a first position, and a second portion, capable of closing off all or part of the auxiliary pipe when the shutter is in a second position, and
at least one seal carried by at least one of the first and of the second portion of the shutter and arranged so as to interpose itself between at least one zone of the said portion and at least one zone of the body when the shutter is in the first or the second position.

The above valve affords reduced soiling. Leaks can also be reduced when the first, and respectively the second, portion of the shutter closes off all or part of the first, and respectively the second, pipe.

Within the meaning of the present application, “shaft” and “rod” are synonymous.

The shutter can be arranged so that in a plane orthogonal to the rod, one of the portions is interposed between the rod and the other portion.

The shutter can be pivotably mounted between:
an open position, and
a closed position in which the first portion closes off the main pipe.

Preferably, the seal is not directly in contact with the body when it is in the open position.

Preferably, the second portion closes off only one part of the auxiliary pipe when the shutter is in the open position.

During its movement, the shutter can assume only one closed position, in which the seal comes into contact with the body.

The valve can be a valve with three ways at most.

The closed position, in which the shutter closes off the pipe, and the open position can each be extreme positions for the pivoting of the shutter. In other words, the pivoting of the shutter between the open position and the closed position defines the maximum amplitude of the shutter's rotational movement.

In one embodiment of the invention, the seal is carried by the second portion of the shutter and is arranged so as to interpose itself between at least one zone of the said portion and at least one zone of the body when the shutter is in the second position. This thus ensures the tightness of the main pipe in relation to the auxiliary pipe when the shutter is in the second position.

In another embodiment of the invention, the seal is carried by the first portion of the shutter and is arranged so as to interpose itself between at least one zone of the said portion and at least one zone of the body when the shutter is in the first position. This thus ensures the tightness of one part of the main pipe in relation to the auxiliary pipe and of the other part of the main pipe when the shutter is in the first position.

In another embodiment of the invention, a seal is carried by the second portion of the shutter and is arranged so as to interpose itself between at least one zone of the said portion and at least one zone of the body when the shutter is in the second position and another seal is carried by the first portion of the shutter and is arranged so as to interpose itself between at least one zone of the said portion and at least one zone of the body when the shutter is in the first position.

The seal is carried by the first or the second portion of the shutter. It is, for example, fixed permanently on the said portion or, as a variation, it is fixed removably.

The seal can come into contact with the body when the shutter is in the position in which the seal is interposed between one of the portions of the shutter and the body. When the first, or respectively the second, portion of the shutter carrying the seal moves, the seal can scrape against the wall of the main, or respectively auxiliary, pipe. In this way, soiling in the valve can be reduced.

The seal is made, for example, of stainless steel or silicone.

The seal can extend around all or part of the perimeter of the said portion of the shutter.

The seal can extend continuously around the complete perimeter of the first or second portion of the shutter.

As a variation, the seal does not extend continuously. Several distinct segments of the seal can be carried by the said portion, for example along a same perimeter of the said portion of the shutter. Several distinct zones of the second, or respectively the first, portion of the shutter and body are therefore in contact via one of the seal segments when the shutter is in the second, or respectively the first, position. Apart from in these zones, an empty space can exist between the body and the second, or respectively the first, portion of the shutter when the shutter is in the second, or respectively the first, position.

The first and/or second portions can be in the form of a plate, namely they can have a dimension, henceforth referred to as “thickness”, much smaller than their other two dimensions. In this case, the seal may or may not extend continuously around the rod along which the thickness is measured.

The plate forming the second, or respectively the first, portion can be rectangular in shape, in which case the seal is rectangular when it extends continuously around the plate.

As a variation, the plate forming the second, or respectively the first, portion can be disc-, or half-disc-shaped, in which case the seal is annular or partly annular when it extends continuously around the plate.

A groove can be made around all or part of the perimeter of the first or second portion and the seal can partly rest in this groove.

The seal is for example force-fitted into this groove and can protrude outwardly therefrom once in place in the groove.

The shutter can be offset radially in relation to the rod. Within the meaning of the present invention, “radially” means in a plane perpendicular to the rod. The rod has, for example, in this plane a circular section and the radial offset can mean that the shutter does not extend in the same way from each side of a diameter of the rod in the said plane. When the portion of the shutter coming into contact with the rod is in the form of a plate, “radially offset” can mean that the centre of the rod is not located midway between the opposite faces of the plate.

The second portion can come into contact with the rod on a first side and come into contact with the first portion by a second side opposite the first side. The second portion of the shutter is then located between the rod and the first portion of the shutter.

In a plane perpendicular to the rod, the rod can be closer to a first end of the first side than to a second end of this first side, the said second end being opposite the first end. The rod can in particular be positioned at the first end of the second portion. Positioning the rod in relation to the ends of the first side of the second portion of the shutter in this plane can enable a pivoting of large amplitude of the shutter in the body.

The first portion and the second portion can be distinct parts rigidly connected together. Standard parts can therefore be used to make each portion of the shutter. The coupling between the first and the second portion so that the latter are integral can be achieved by screwing, welding or riveting, for example.

The second side of the second portion can be attached to a first side of the first portion and the said sides can extend across all planes, when the said sides are planes.

In a plane perpendicular to the rod, the first portion of the shutter can extend for the most part from a first side of the rod and the second portion of the shutter can extend for the most part from a second side of the rod, opposite the first side.

A recess is for example made in the wall of the auxiliary pipe and in the wall of the main pipe and the first portion can rest in this recess when the shutter is in the second position.

Another aim of the invention, according to another of its aspects, is a thermal engine air circuit comprising a valve as defined above.

The valve can be placed in the air circuit at a place therein in which a branch connection is located. The valve can for example be located downstream of the engine, in the engine's exhaust circuit where the recirculation loop originates allowing exhaust gases to be re-injected at the engine's intake.

In a variation, the valve is located upstream of the engine, in the engine's intake circuit into which the gas recirculation loop feeds.

The gas recirculation loop can be a “low pressure” or a “high pressure” loop, depending on whether it originates upstream or downstream of the air circuit turbine.

The thermal engine is for example an internal combustion engine, petrol- or diesel-powered for example, and can be installed in a motor vehicle.

The invention focuses, according to another of its aspects, on the use of a valve as described above in a thermal engine's air circuit, the main pipe belonging to the engine's exhaust circuit and the auxiliary pipe belonging to an exhaust gas recirculation loop enabling said exhaust gases to be re-injected at the engine's intake.

As a variation, the valve can be in the form of a metering device or a butterfly valve.

A better understanding of the invention will emerge from the following description of a non-limiting embodiment thereof and an examination of the accompanying drawing in which the single FIGURE is a schematic representation of an example of a “three-way” valve according to the invention.

This FIGURE shows a “three-way” valve 1. The valve 1 comprises a body 2 and a shutter 3 movable in the body 2 via a rod 4. The rod 4 in this example has a circular cross-section.

In the body 2 is a main pipe 5 to which an auxiliary pipe 6 connects at a branch connection 7. The body 2 is for example an aluminium or stainless steel casting.

In the example considered, the body 2 comprises a first part 2a defining.
the wall of the main pipe 5, and
the wall of the auxiliary pipe 6 at the connection branch 7.

The body 2 also comprises a second part 2b defining the wall of the auxiliary pipe 6 at a location other than the branch connection 7.

As shown in the FIGURE, a cavity 8 exists in the first part 2a, near the connection 7.

In the example considered, the main pipe 5 forms part of the exhaust circuit of a vehicle's thermal engine and the auxiliary pipe 6 forms part of a recirculation loop allowing the exhaust gases to be re-injected at the engine's intake. The valve 1 thus allows a variable amount of exhaust gas to be recirculated towards the intake of the thermal engine.

A more detailed description of the shutter 3 now follows. The shutter comprises a first portion 10 and a second portion 11. Each of these portions 10 or 11, in the example described, is in the form of a plate. In the plane of the FIGURE, perpendicular to the rod, these portions 10, 11 are rectangular in shape.

The first portion 10 and the second portion 11 are rigidly connected together, for example by screwing, welding or riveting.

The first portion 10 comprises a first face 13 coming into contact with a second face 14 of the second portion 11. In the example considered, the faces 13 and 14 are flat and coplanar.

The second portion has a first face 15 opposite the second face 14. The second portion 11 comes into contact by the first face 15 with the rod 4. As shown in the FIGURE, the second portion 11 is radially offset in relation to the rod 4, not passing through a central zone of the rod 4. Furthermore, the rod 4 is in this example closer to one end 16 of the first face 15 than the other end 17 of the said face 15, when observed in the plane of the FIGURE, in other words perpendicular to the rod 4.

The second portion 11 and the rod 4 can be connected together without play.

In the example shown, a groove 18 is made all around in the direction along which the thickness of the plate forming the second portion 12 is measured. A seal 19 is arranged in this groove 18.

As a variation, a plurality of seal segments can be received in the groove 18 or in a plurality of corresponding grooves.

As shown in the FIGURE, the seal 19 has one portion arranged in the groove and one portion protruding beyond the groove 18 and beyond the second portion 11.

The first portion 10 moves between a second position in which it rests partly in the cavity 8, then being substantially parallel to the wall of the main pipe 5 at the branch connection 7, and a first position in which it extends across the main pipe 5. In the example described, in this first position, the first portion 10 does not close off the main pipe but ensures a counter-pressure towards the exhaust.

The second portion 11 moves between a first position in which it extends substantially parallel to the wall of the auxiliary pipe 6 at the branch connection 7 and a second position in which it extends across the auxiliary pipe 6, being notably perpendicular to the wall of the auxiliary pipe 6 at the branch connection 7.

When the first 10 and second 11 portions are in the first position, the shutter 3 is in the first position in which it encourages the recirculation of exhaust gas towards the engine's intake.

When the first 10 and second 11 portions are in the second position, the shutter 3 is in the second position in which it opposes, or even prevents, the recirculation of exhaust gas towards the engine's intake. The seal 19 is dimensioned so as to fill the empty space between the first portion 11 and the wall of the auxiliary pipe 6 when the shutter is in the second position, in order to ensure the tightness of the auxiliary pipe 6 in relation to the main pipe 5.

The invention is not limited to the example described above.

In other embodiments of the invention, several seals can be carried by the second portion 11. These seal are, for example, positioned at different heights along the direction in which the thickness of the plate is measured.

Each seal can then extend continuously around in the said direction. As a variation, each seal is formed by seal segments. In this case, from one seal to the other, the seal segments can be exactly superimposed or staggered in relation to each other.

The expression “comprising a” must be understood as being synonymous with the expression “comprising at least one”, unless stated otherwise.

1. A valve for a thermal engine's air circuit, comprising:
a body in which are arranged a main pipe and an auxiliary pipe feeding into the main pipe;
a shutter pivotably mounted in the body on a rod, the shutter comprising a first portion, capable of closing off all or part of the main pipe when the shutter is in a first position, and a second portion, capable of closing off all or part of the auxiliary pipe when the shutter is in a second position; and
at least one seal carried by at least one of the first and of the second portion of the shutter and arranged so as to interpose itself between at least one zone of the said portion and at least one zone of the body when the shutter is in the first or the second position, the seal extending along all or part of the perimeter of the said portion of the shutter.

2. The valve according to claim 1, the seal being carried by the second portion of the shutter and being arranged to interpose itself between at least one zone of the said portion and at least one zone of the body when the shutter is in the second position.

3. The valve according to claim 1, the shutter being offset radially in relation to the rod.

4. The valve according to claim 1, the second portion coming into contact with the rod by a first side and coming into contact with the first portion by a second side, opposite the first side.

5. The valve according to claim 4, in a plane perpendicular to the rod, the rod being closer to a first end of the first side than to a second end of the first side, the said second end being opposite the first end.

6. The valve according to claim 4, the first portion and the second portion being distinct parts rigidly connected together.

7. The valve of claim 6, the second side of the second portion being attached to a first side of the first portion and the said sides extending across all planes.

8. The valve according to claim 1, in a plane perpendicular to the rod, the first portion extending for the most part from a first side of the rod and the second portion of the shutter extending for the most part from a second side of the rod, opposite the first side.

9. The valve according to claim 1, the shutter being arranged so that in a plane orthogonal to the rod, one of the portions is interposed between the rod and the other portion.

10. The valve according to claim 1, the shutter being pivotably mounted between:
an open position, and
a closed position in which the first portion closes off the main pipe.

11. The valve according to the claim 10, being configured so that, when it moves, the shutter assumes only one closed position, in which the seal comes into contact with the body.

12. The valve according to claim 10, the open position and the closed position each being extreme positions for the pivoting of the shutter.

13. Use of a valve according to claim 1 in a thermal engine's air circuit, the main pipe belonging to the engine's exhaust circuit and the auxiliary pipe belonging to an exhaust gas recirculation loop allowing said exhaust gases to be re-injected at the engine's intake.
